(19) United States
(12) Patent Application Publication
(10) Pub. No.: US 2021/0074186 A1
(43) Pub. Date: Mar. 11, 2021

(54) Hand-Held Sign Frame Systems

(71) Applicant: Roy John Weis, McMinnville, OR (US)

(72) Inventor: Roy John Weis, McMinnville, OR (US)

(21) Appl. No.: 16/561,099

(22) Filed: Sep. 5, 2019

(51) Int. Cl. G09F 7/20; G09F 21/02

(52) U.S. Cl. CPC G09F 7/20; G09F 2007/1843; G09F 21/02

(57) ABSTRACT

A hand-held, portable frame to support signs for street side promotions. This rugged, lightweight frame is made from aluminum or plastics and consists of various joints interconnected by square shaped insert tubes into a figure 8 configuration with optional extensions. To fasten, thumb screws attached to the joints that when twisted, pinch the insert tubes. The bottom brace member is a foot support. The middle brace member forms a hand support and is used as a body rest by leaning on it. Signs are attached only at the top allowing them to swing with the wind; minimizes user fatigue. Double sided signs can be used for viewing from opposite directions. All tubes come in multiple lengths and can couple together to form larger members. This frame stretches horizontally, vertically and in width providing numerous configurations. Recommended range is 2 to 6 feet horizontally and 8 to 12 feet vertically.

### FIELD OF THE INVENTION

This present invention relates generally to hand-held signs, and particularly to hand-held sign frames and hand-held sign frame systems to portably support signs for street side advertising purposes and promotions.

### BACKGROUND

Businesses, schools and other entities have long employed the use of signs to attract, inform, and/or direct customers, such as by advertising a special promotion or event, providing directions to a specific location, and so forth. One popular technique is to utilize or employ individuals to hold signs outside or otherwise near an entities' location in an effort to engage passersby, such as stationing a human sign holder on the side of a busy street in order to draw the attention of motorists. It is thought that a sign that is displayed by a human sign holder is better at attracting and maintaining attention, as compared to the static nature of fixed signs, because the individual holding a hand-held sign may twirl, wave, or otherwise move the sign around, interact with passersby by waving or gesturing, dress in a costume or otherwise add a performance element to the display of the sign, and so forth. Also, many cities have ordinances limiting fixed stationary sign usage but not necessarily hand-held sign usages.

This technique suffers from many drawbacks, some of which are related to sign visibility. For example, the elevation at which a hand-held sign may be displayed is generally limited to how high a person can raise the sign over his or her head, which may limit the visibility range of the sign. Also, a hand-held sign should be large enough to display information effectively, but if too large, the sign may be too cumbersome; a user may not have a hand free to wave to traffic. Further, large signs may block the individual holding the sign from view reducing the interactive impact with motorists and passersby. User fatigue from standing and holding a sign for long periods of time is a major issue, especially if the individual is expending energy to move him or her, and/or the sign, around. Additionally, forcibly holding a sign against the wind contributes to fatigue and safety. Another drawback is the difficulty for passersby to read the sign's message due to the spinning and twirling actions of the sign users; sign is not stationary.

Therefore, what is needed is a hand-held sign frame that is lightweight, sturdy, adjustable, wind resistant, portable, durable, rust proof and that can easily elevate a large readable sign above traffic with minimal user fatigue.

### SUMMARY

Various embodiments of a hand-held sign frame, or hand-held sign frame system, are disclosed herein. The basic embodiment is a hand-held sign frame made from aluminum or plastic tubes and is adapted to support indicia-bearing media (e.g., signs). This frame consists of 3 horizontal brace members, 4 vertical brace members and 6 joints. When assembled, the sign frame becomes a rectangular FIG. 8 configuration with a bottom portion supporting an upper window where the signs are displayed. The bottom brace member engages the ground and forms a foot support adapted to receive a user's foot thereon. The middle brace member forms a hand support adapted to receive a user's hand thereon. This same middle brace member can also be used as a body rest by having the user leaning on it with arms folded across it. The top brace member provides the attachment points for the signs. The signs are attached only at the top of the frame allowing them to freely swing inside the windows of the frame providing a wind resistant capability with minimal user fatigue. Two horizontal extension arms can be overhung from the frame to greatly increase the sign display area. These arms connect directly to the top brace member and as one-piece, set inside “Clamp” joints attached to the top of the sign frame.

Each of the brace members is basically a variety of joints that are interconnected with insert tubes that slide inside the joints. Attached to the joints are thumb screws and when twisted, press against and pinch the insert tubes to produce a snug secure fasten. To make more rugged, some slop or spacing between the joints and insert tubes is designed in, so if any brace members become dirty or damaged, the insert tubes may still slide and still be snuggly fastened using the thumb screws. A connector joint can be used to connect two insert tubes to form a larger brace member. Additional connectors and insert tubes could be attached to form even larger members. Optional signs can be hung to the either side of the frame by inserting a 4 way cross joint in the frame to which additional arms can be mounted. Additional signs can be hung perpendicular to the frame by inserting extra joints and then installing arm members. This is possible because the insert tubes are square allowing the extra joints to be turned 90 degrees relative to the frame.

All the brace members can telescope or stretch up to the point where the not-to-exceed markings stamped onto the insert tubes, have become visible. If stretched beyond the markings, the insert tube has slid too far and the thumb screw will miss it. The overall length of the brace members can also be changed by providing tubes of different lengths, such as in 1, 2, 3 and 4 foot increments. The extra tubes, having tubes of varying lengths, combined with the telescoping capabilities, provides an extensive range of frame configurations for accommodating a wide assortment of indicia-bearing media sizes including double sided versions for viewing in opposite directions. The recommended configuration range is 2 to 6 feet horizontally and 8 to 12 feet vertically.

The sign frame, being made from aluminum or plastic, is sturdy, rigid, rugged, rust proof, and weighs about 10 pounds. It can easily be disassembled for storage by simply un-twisting the thumb screws. In some embodiments, other fastening mechanisms or combinations thereof may be used including snap buttons, bolts with wing nuts, and so forth. In other embodiments, other tube sizes, tube wall thicknesses, and dimensions may be optionally used. In other embodiments, the sign frame's components and members may be coated with a reflective paint or powder coat where the reflection and bright colors can help to gain the attention of passersby. In some embodiments, the sign frame may be modified to carry a portable power supply to power any electronics associated with signs.

### BRIEF DESCRIPTION OF THE DRAWINGS

The concepts, features, methods, and component configurations briefly described above are clarified with reference to the accompanying drawings and following detailed descriptions. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the inventions.

FIG. 1 is an example embodiment of a hand-held sign frame shown supporting signs thereon with a user's hand holding the middle brace member and a user's foot placed on the bottom brace member to stabilize the frame. Optional extender arms are shown projecting at the top right, middle left, and at the top left perpendicular to the frame. All signs are loosely fastened at the top only, allowing the signs to freely swing with the wind. Using a thumb screw fastening mechanism, the frame telescopes horizontally, vertically and in width allowing the use of a variety of sign sizes including double sided signs for viewing in opposite traffic directions. Shown at the top is an expanded view of the tube coupling mechanism.

FIG. 2 illustrates tipping the frame at an inclined angle with one of the user's hands holding the sign frame and the other hand free to wave at passersby. Also shown is an optional extender arm projecting perpendicular to the left.

FIG. 3 shows use of the frame as a body and arm rest plus use of 2 extender arms at the top and 1 to the middle left.

FIG. 4 illustrates how the frame can elevate signs above traffic and obstacles. Motorists from outer highway lanes can easily view the signs over other vehicles. With the frame being a stable platform, the signs can remain stationary making it easier to read the sign's message while still watching the body actions of the user. Reflective bright paint on the sign frame helps to attract the attention of passersby.

FIG. 5 illustrates how easy it is for the user to physically elevate the frame with little effort and carry it up and down streets. The frame weighs about 10 pounds.

FIG. 6 illustrates the telescoping capabilities of the frame. The frame can stretch substantially both horizontally, vertically and in width. Much larger signs can be displayed at extended elevations, and if desired, utilizing two persons as sign holders. Portable lights attached to the frame help to illuminate the signs. Also shown are helpers for the sign holders who are free to separately engage passersby.

FIG. 7A illustrates the two types of tubes used in the frame and the thumb screw fastening mechanism. Also shown are the “not-to-exceed” markings when telescoping or stretching the frame.

FIG. 7B is a side view of the 2 tubes shown in FIG. 7A.

FIG. 8A illustrates using the connector joint to connect two insert tubes that are used in the horizontal and vertical brace members shown in FIG. 1.

FIG. 8B illustrates using additional connectors and insert tubes shown in FIG. 8A to form a much larger brace member.

FIG. 9 is an oblique, partial view of the “T” joints shown in FIG. 1.

FIG. 10 is an oblique, partial view of the “Elbow” joints shown in FIG. 1.

FIG. 11 is an oblique, partial view of the “End” joints shown in FIG. 1. FIG. 12A is an oblique, partial view of the “Clamp” joints used at the top of the frame shown in FIG. 1.

FIG. 12B is a side view of the “Clamp” joint shown in FIG. 12A.

FIG. 13 is an oblique, partial view of the “Cross” joint shown in FIG. 1.

FIG. 14 is an expanded view of the lower, middle and top brace members shown in FIG. 1.

FIG. 15 is an exploded elevation view of the sign frame shown in FIG. 1.

### DETAILED DESCRIPTION OF THE DRAWINGS

In the following paragraphs, the present embodiments will be described in detail by way of example with reference to the attached drawings. Throughout this description, the preferred embodiment and examples shown should be considered as exemplars, rather than as limitations on the present embodiments.

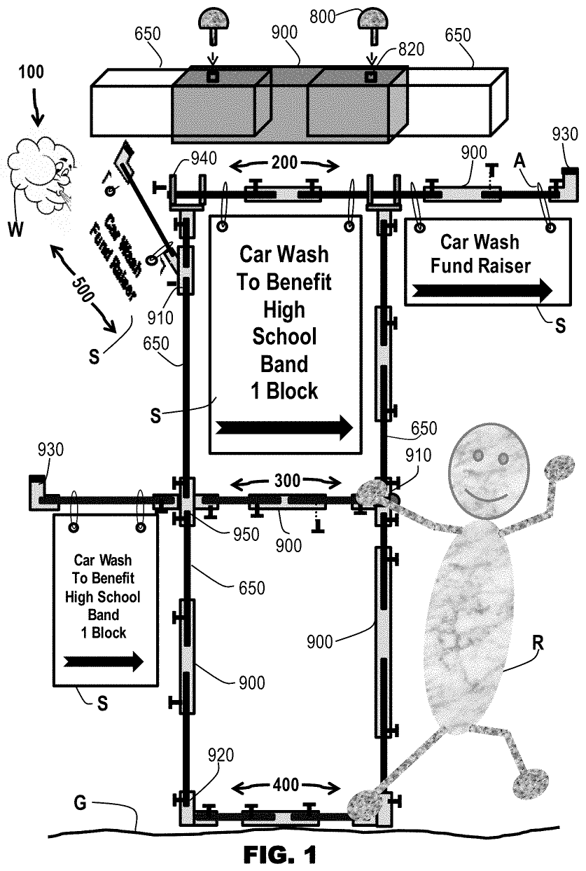

FIG. 1 illustrates an embodiment of the hand-held sign frame 100 having a top brace member 200, a middle brace member 300, and a bottom brace member 400. When these 3 members are interconnected with vertical members, frame 100 becomes a rectangular figure 8 configuration from which overhanging members can optionally be attached. Signs S are shown being loosely mounted only at the top so they can freely swing with the wind W; minimizes user fatigue. Middle brace member 300 is used by user R as a hand support to hold and stabilize frame 100. It can also be used as a body rest by having user R physically lean on member 300 with arms folded across member 300. Bottom brace member 400 engages the ground G and can be anchored by placing user R's foot on top of member 400. Frame 100 can be made from plastics or aluminum and is basically a variety of joints that are interconnected with insert tubes 650 that slide inside the joints. Attached to the joints are thumb screws 800 and when twisted, press against and pinch insert tubes 650 to produce a snug secure fasten. This fastening mechanism is illustrated at the top of FIG. 1 using connector joint 900. As shown in FIG. 1, these connector joint's 900 can come in multiple lengths and can telescope by allowing the insert tubes to realign before fastening. Insert tubes 650 are square shaped allowing add-on joints to be rotated 90 degrees providing frame 100 with numerous configurations and the ability to stretch horizontally, vertically and in width.

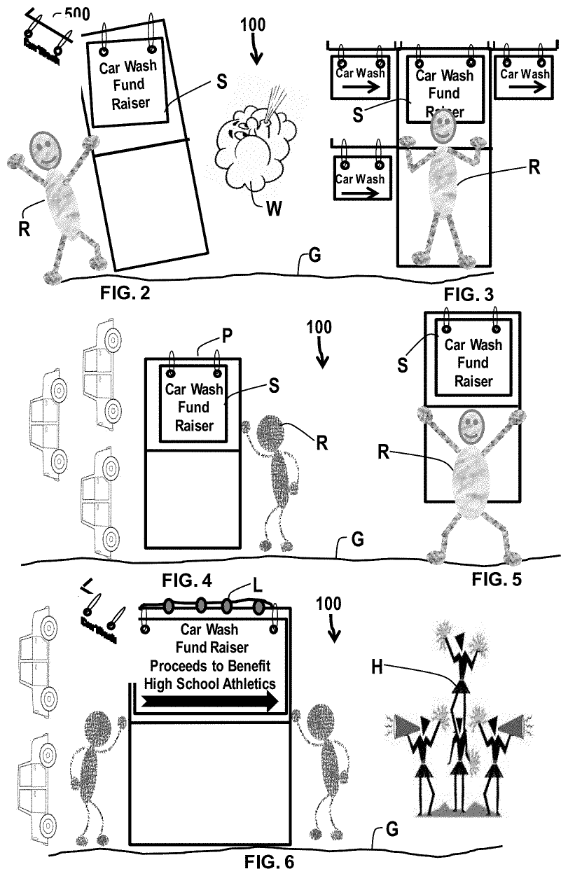

FIGS. 2-6 illustrate the capabilities of the hand-held sign frame 100. Not shown is frame 100's capability of using double sided signs for simultaneous viewing in opposite directions. FIG. 2 shows frame 100 being held by user R at an inclined angle with one hand free to wave at passersby. Member 500 is an additional attachment and as shown can be optionally rotated 90 degrees to provide an arm that is perpendicular to the structure. Frame 100 is wind resistant; signs are allowed to swing. FIG. 3 illustrates using frame 100 as a body and arm rest showing user R in a leaning position with arms folded across the middle brace member and user R's feet stabilizing the bottom brace member. Also shown are 2 overhanging extensions at the top of frame 100 and a third extension at the middle left.

FIG. 4 shows how frame 100 can elevate signs above traffic and obstacles. Traffic from outer highway lanes can easily view the signs over other cars. Also shown is using an optional reflective bright paint P on frame 100 to further attract the attention of passersby. With frame 100 being a stable platform, the signs are essentially stationary making it easier to read the sign's message while still watching the body actions of user R and helpers H. Many people who hold signs move the signs around so fast that their message is hard to read. FIG. 5 shows user R physically elevating the entire frame 100, which weighs about 10 pounds, and is sufficiently lightweight to be lifted and carried along streets. Other user actions include rocking frame 100 from side to side, twirling frame 100 around one corner of bottom brace member 400, and user R turning around 180 degrees for engaging traffic in the opposite direction. Frame 100 is sufficiently rigid and stable to withstand such movements and/or to bear other forces exerted on the frame.

FIG. 6 illustrates the telescoping capabilities of the frame. In the basic embodiment, the recommended telescoping range is 2 to 6 feet horizontally and 8 to 12 feet vertically. However, additional tubes and joints can easily be coupled to form much longer brace members 200, 300, 400 and 500. In practice, it is believed all users will stay within the stated ranges. This telescoping range feature allows displaying much larger signs at extended elevations and if desired, using two sign users R. The addition of portable lights and member 500 which is at a perpendicular angle, enhances the sign display. Also shown are helpers H who are free to separately engage passersby and directing their attention to the sign and its message.

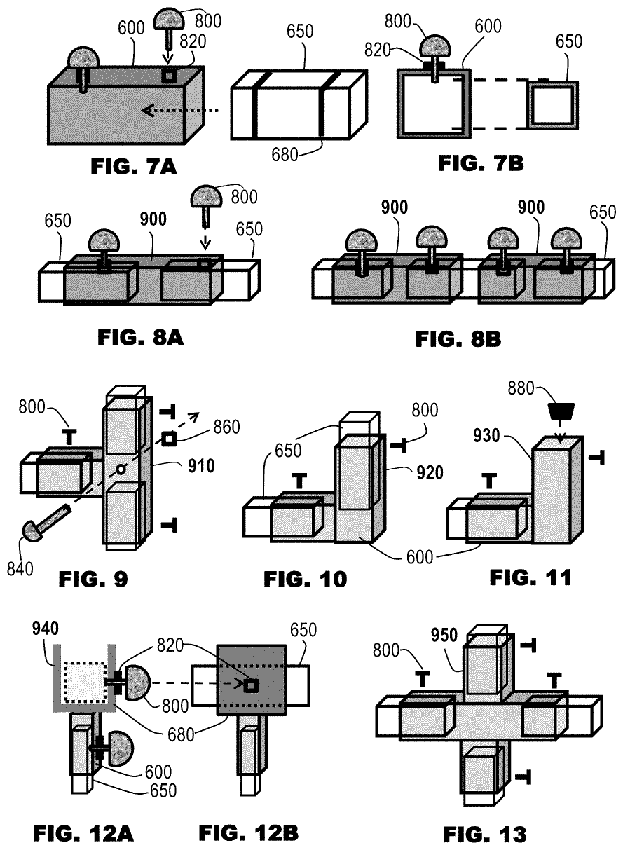

FIGS. 7A-13 in this embodiment show all the joints being fabricated from aluminum tubes. In other embodiments, these joints and insert tubes 650 can optionally be made from plastic using the same design concepts. FIG. 7A illustrates the two types of aluminum tubes used in frame 100 and the thumb screw fastening mechanism. The smaller insert tube 650 slides inside the larger host tube 600. An aluminum nut 820 is welded to both ends of host tube 600 plus all the joints. These nuts 820 are centered on a hole (not shown) into which is received a threaded thumb screw 800 or fin bolt. As the thumb screw 800 is twisted, it presses against and pinches insert tube 650. This pinching action provides a secure and snug, fastening mechanism. Embedded on both ends of insert tube 650 are “not-to-exceed” telescoping markings 680. If during assembly of frame 100 a marking 680 becomes visible, it informs user R not to stretch or telescope any further. If stretched beyond the markings, the insert tube 650 has slid too far and the thumb screw will miss it. All thumb screws 800 and corresponding nuts 820 are located about 2 inches from the end of host tube 600 and every joint's branches. The 680 markings are located about 3 inches from the ends of insert tube 650. The net effect is a 1-inch overlap buffer is created for thumb screw engagement. In some embodiments, other fastening mechanisms, or combinations of other fastening mechanisms, may be used including snap buttons, bolts with wing nuts, and so forth. In another embodiment, the joints may be made from plastics wherein, nuts may not be required and threaded holes could be drilled directly into the joints for the thumb screws. Plastic joints could take on many shapes such as having ribs or spines for reinforcement.

FIG. 7B is a side view of the aluminum tubes 600 and 650 shown in FIG. 7A. Host tube 600 has a square cross section of 1.25″×1.25″ with a wall thickness of 0.045″. Tube 600 is used in fabricating all the joints shown in FIGS. 8A-13. The smaller insert tube 650 has a square cross section of 1.10″×1.10″ and a wall thickness of 0.045″. When the “connector” joint 900 in FIG. 8A is fully compressed (the 2 insert tubes touch), the combined effective wall thickness and associated strength is essentially doubled to 0.090. Insert tube 650 easily slides inside host tube 600 and all the joints. Having a square cross section, the joints and tubes 650 can easily be rotated 90 degrees allowing them to form member 500 shown in FIG. 1, which is perpendicular to the main structure. By design, there is some slop or space between the joints and insert tubes so if any become dirty or damaged, the insert tube 650 may still slide and be snuggly fastened using the thumb screw mechanism. In other embodiments, the tube sizes, dimensions, and wall thickness may change but the concept of one tube sliding inside the other remains the same.

Shown in FIG. 8A is “connector” joint 900 which is used to connect two smaller insert tubes 650 to make larger brace members in frame 100. As shown in FIG. 8B, these members can then interconnect with other connecting joints 900 and insert tubes 650 to form even larger members. It is these members that are used to form braces 200, 300, 400 and 500 shown in FIG. 1. In other embodiments, connector joints 900 are not required because insert tubes 650 by themselves, can interconnect all the joints. In the basic embodiment, “connector” joints 900 and both insert tubes 650 will come in 1, 2, 3 and 4 foot lengths and multiple quantities with all included in a customer kit. Depending on the length of “connector” 900 and the other joints, the range of pinching positions is continuous providing a wide range of telescoping positions. This combination of member lengths and quantities plus the telescoping capabilities provides an extensive range of frame 100 configurations.

FIG. 9 is an oblique, partial view of “T” joints 910 primarily used in middle brace member 300. An additional “T” joint can also be attached and rotated 90 degrees to form perpendicular member 500. The bolt 840 and lock nut 860 are used as a stop when connecting the vertical tubes 650. FIG. 10 is an oblique, partial view of the “elbow” joints 920 used in brace member 400. FIG. 11 is an oblique, partial view of the “corner” joint 930 which is attached to all overhung extensions to help prevent a hung sign S from sliding off. The plastic insert 880 is pressed into joint 930 to cap the joint. FIG. 12A is an oblique, partial view of “clamp” joint 940 which is used to fasten the top brace member 200 and overhung extensions to frame 100. FIG. 12B is a side view of FIG. 12A. “Clamp” joint 940 is made from an aluminum channel 680 that is welded to the larger host tube 600. Brace member 200 and any extensions set inside channel 680 as one piece and are fastened using thumb screw 800 that is attached to channel 680. FIG. 13 is an oblique, partial view of “cross” joint 950 which can optionally be used in brace members 200, 300 and 500.

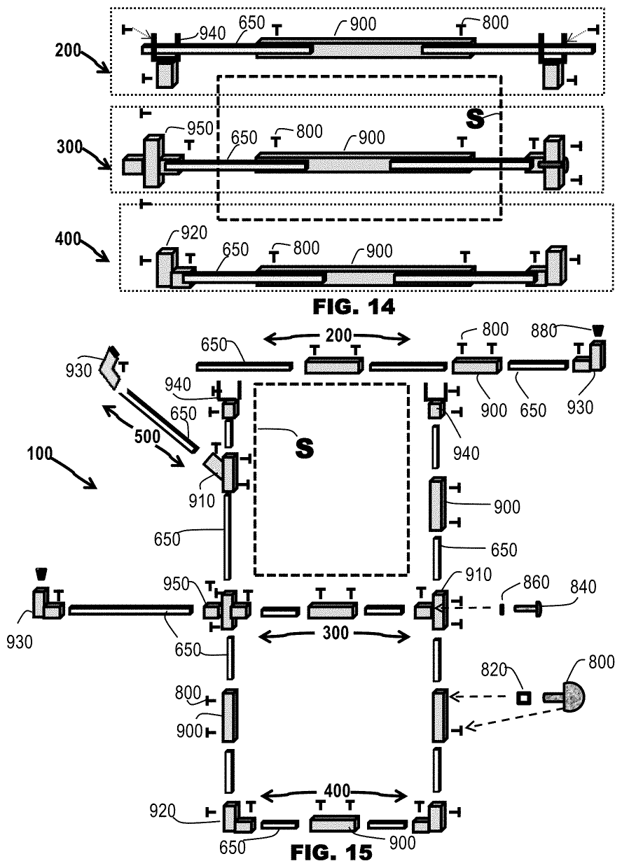

FIG. 14 is an expanded view of brace members 200, 300 and 400 and illustrates the assembly of frame 100. The first step is to stretch all 3 members over sign S allowing a 2-inch horizontal gap on both sides of sign S. Make sure all 3 members are at the same length and then fasten using thumb screws 800. Step 2 is to stretch the bottom 2 vertical members in FIG. 415 to the desired length, attach to bottom brace member 400 and then to middle brace member 300. Step 3 is to stretch the top 2 vertical members to the desired length, insert an extra “T” joint for perpendicular member 500, and then attach to top brace member 200 and then to middle brace member 300. Step 4 is to attach member 500 to the extra “T” joint in step 3. Step 5 is to attach any overhanging extensions directly to top brace member 200 and to middle brace member 300.

FIG. 15 is an exploded elevation view of the frame 100 embodiment shown in FIG. 1. There are numerous other configurations ranging from a simple figure 8 frame to adding multiple extensions and member lengths.

Only the top portion of any signs S are attached to frame 100. As shown in FIG. 1, attachment mechanisms A include zip-ties, cords, clips and so forth. Signs should be only loosely attached to provide the greatest freedom to swing. As shown in FIGS. 14 and 15, providing a 2-inch gap between all sides of frame 100 and all sides of sign S, allows the signs to swing back and forth unobstructed thus making it much easier to maintain frame 100 upright in windy conditions. This wind resistant feature substantially reduces user fatigue. If all sides of sign S were tied down, a considerable opposing force would be required from user R to keep frame 100 upright.

The preferred material for signs S should be rigid, lightweight, and weather-proof such as laminated board and corrugated plastic. A reflective sign surface such as using reflective paint helps in gaining the attention of passersby. Other materials or types of media may be used, such as displays including lights or other electronics, and so forth. In other embodiments, frame 100 may be configured to carry a portable power supply such as a battery case, to power any electronics attached to frame 100.

The middle brace member 300 is used by user R as a hand support to hold and stabilize frame 100. As illustrated in FIG. 3, this same middle brace member 300 can be used as a body rest by having user R physically lean on member 300 with arms folded across member 300. Some embodiments may include additional components, such as padded or cushioned gripping regions disposed on member 300. The bottom brace member 400 engages the ground G and can be anchored by placing user R's foot on top of member 400. Some embodiments may include ground-engaging pads or feet on member 400, such as to prevent contact with the ground surface, minimize wear on member 400 itself, and so forth. In other embodiments, the vertical and side members may be provided with additional gripping regions to help a user in tilting frame 100 sideways in FIG. 2 or raising the frame above the ground surface in FIG. 5. Optionally and as illustrated in FIG. 4, all the frame 100 components, brace members and overhanging extensions can be coated with a reflective paint P or powder coating where the reflection and bright colors can help to gain the attention of passersby.

Although not required to all embodiments, frame 100 is of multi-piece construction with few parts and most being common. This may result in lower manufacturing and storage cost. Further, providing frame 100 components in a compact customer kit to be assembled by a user, may reduce shipping costs. Also, custom reader boards may be offered for easy attachment to frame 100. These boards have grommets on all four corners so they can be connected with other boards to increase overall sign size. All components and reader boards nest well in the same shipping container that meets requirements for inexpensive air freight with home delivery.

It will be apparent to those skilled in the art that various changes in form and detail may be made to the present invention without departing from the spirit and scope of the invention. The present invention is intended to embrace all such alternatives, modifications and variances that fall within the scope of the appended claims.

I claim:

1. A hand-held frame system to portably support indicia-bearing media (e.g., signs), the frame system comprising:
a series of joints that are interconnected by square shaped insert tubes into a rectangular figure 8 configuration with optional overhanging extensions;
a adjustable top brace member connected to 2 “Clamp” joints that provides the mounting sites for the indicia-bearing media;
a adjustable bottom brace member connected to 2 “Elbow” joints that provides a foot support adapted to receive a user's foot thereon;
a adjustable middle brace member connected to 2 “T” joints that provides a hand support adapted to receive a user's hand thereon;
an optional “Connector” joint that connects 2 insert tubes allowing the structure to stretch horizontally, vertically and in width;
adjustable vertical brace members that interconnect the top, bottom, and middle brace members into a rectangular figure 8 configuration;
an optional “Cross” joint that can be added to the frame and/or to replace other joints in the frame to provide additional mounting sites to the sides and top of the frame;
adjustable perpendicular brace members that can be optionally attached to both sides of the frame to provide extra mounting sites at a 90 degree angle relative to the frame; and
adjustable extension arm brace members that can be attached to both sides of the top brace member to provide extra mounting sites for the indicia bearing media.

2. The frame system of claim 1, wherein the joints have square shaped openings and cavities allowing the square insert tubes to slide inside the joint's branches.

3. The frame system of claim 1, wherein the joints in claim 2 are further comprised of a fastening mechanism consisting of thumb screws attached to the joint's branches that when twisted, press against and pinch the smaller insert tubes to produce a snug, secure fasten.

4. The frame system of claim 1, wherein the brace members can telescope or stretch up to the point where the not-to-exceed markings embedded onto the insert tubes have become visible; if stretched beyond the markings, the insert tubes have slid too far and the thumb screws will miss pinching the insert tubes.

5. (canceled)

6. The frame system of claim 1, wherein the joints in claim 3, by using their thumb screws, allows the attached brace members and insert tubes to be compressed for easy attachment and subsequently stretched for firm fastening by the thumb screws.

7. The frame system of claim 1, wherein the overall length of the brace members can be changed by coupling additional joints and insert tubes to the brace members.

8. The frame system of claim 1, wherein the overall length of the brace members can be further changed by providing tubes of different lengths, such as in 1, 2, 3 and 4 foot increments.

9. The frame system of claim 1, wherein combining the telescoping capabilities in claim 4 with the perpendicular frame members in claim 1, with the additional joints and tubes in claim 7 and with using the multiple tube lengths in claim 8, together provides an extensive range of frame configurations for accommodating a wide assortment of indicia-bearing media sizes including double sided versions for viewing in opposite directions.

10. The frame system of claim 1, wherein the extension arm brace members connect directly to the top brace member and then as one-piece sets inside “Clamp” joints attached to the top of the frame system and is then fastened using thumb screws attached to the “Clamp” joints.

11. The frame system of claim 1, wherein includes designed-in slop or space between the joints and insert tubes so if any joints or insert tubes become dirty or damaged, the insert tubes may still slide and be snuggly fastened using the thumb screws in claim 3.

12. The frame system of claim 1, wherein the indicia-bearing media are loosely fastened at the top only allowing them to freely swing thus providing a wind resistant capability with minimal user fatigue and wherein a variety of store bought attachment mechanisms can be used including zip-ties, cords, and clips.

13. The frame system of claim 1, wherein the middle brace member functions as a body rest and is adapted to bear a downward force exerted by a user leaning on the middle brace member with arms folded across the middle brace member.

14. The frame system of claim 1, wherein the frame joints and insert tubes can be adapted or modified to be made from one or more alternate materials including aluminum, plastics and composites.

15. The frame system of claim 1, wherein can be adapted or modified to use alternate tubing sizes, dimensions, wall thicknesses and lengths.

16. The frame system of claim 1, wherein that can be adapted or modified to utilize alternate fastening mechanisms including thumb screws, snap buttons, and bolts with wing nuts.

17. The frame system of claim 1, wherein it can be outfitted with a portable power supply to power lights and other electronics attached to the frame.

18. The frame system of claim 1, wherein the frame can be adapted or modified to use gripping materials such as pads and cushions to help a user in handling, tilting and twirling the frame plus raising the frame above the ground.

19. The frame system of claim 1, wherein the bottom brace member can be adapted or modified to use ground-engaging pads or feet to prevent contact with the ground surface and to minimize wear.

20. The frame system of claim 1, wherein all of the frame's components can be coated with a reflective paint or powder coat where the reflection and bright colors can help to gain the attention of passersby.

21. The frame system of claim 1, wherein the perpendicular frame members are comprised of extra “T” or “Cross” joints that are mounted at a 90 degree angle and are then connected to insert tubes and connector joints to form the member.
